(19) United States
(12) Patent Application Publication
(10) Pub. No.: US 2015/0296067 A1
(43) Pub. Date: Oct. 15, 2015

(54) MOBILE TERMINAL, CONTROL METHOD THEREOF, AND NON-TRANSITORY COMPUTER-READABLE MEDIUM

(71) Applicant: CANON KABUSHIKI KAISHA, Tokyo (JP)

(72) Inventor: Tomohiro Ishihara, Kawasaki-shi (JP)

(21) Appl. No.: 14/675,126

(22) Filed: Mar. 31, 2015

(30) Foreign Application Priority Data
Apr. 14, 2014 (JP) 2014-083105

(51) Int. Cl. H04M 1/725; H04W 12/06; H04W 76/02; H04W 36/14; H04W 4/00; H04B 5/00

(52) U.S. Cl. CPC H04M 1/7253; H04W 4/008; H04B 5/0031; H04W 76/023; H04W 36/14; H04W 12/06

(57) ABSTRACT

A mobile terminal comprises: a communication unit configured to perform near field communication with a peripheral apparatus; a unit configured to switch from near field communication performed by the communication unit to communication via another communication path; and an obtaining unit configured to transmit authentication information of a fax to the peripheral apparatus, and to obtain a fax data set corresponding to the authentication information from the peripheral apparatus via the another communication path.

### BACKGROUND OF THE INVENTION

1. Field of the Invention

The present invention relates to a mobile terminal, a control method thereof, and a non-transitory computer-readable medium.

2. Description of the Related Art

Conventional fax machines print fax data immediately after receiving it, and accordingly they can cause problems. For example, there is the possibility that printed documents having important contents could be seen by another person, or that users may forget to take the printed documents. To solve these problems, fax machines usually have the function of storing fax data in an in-box provided therein, as well as functions called “F code functions”.

F code functions include “confidential function” and “bulletin board function”. The confidential function allows for the storing of fax data in a confidential box which has been created within the apparatus in advance and for which an ID and a password have been set. To store fax data in the confidential box, the sender is requested to transmit fax data with an F code ID and a password added thereto, and the fax data stored in the confidential box is printed when the recipient inputs the F code ID and the password received from the sender. Usually, a confidential box is set and operated by a predetermined organizational group or the like. The bulletin board function provides a bulletin board box for the sender, and allows the recipient to access the bulletin board box and to retrieve the fax data. The bulletin board function is used for non-synchronous correspondence among various quarters concerned, or serves as a substitute for the confidential function when the recipient fax machine does not have sufficient functions: for example, Japanese Patent Laid-Open No. 2003-304383 discloses technology of receiving an F code and outputting received data.

In recent years, mobile terminals such as smartphones and tablet terminals, which are portable apparatuses having a communication function, have become common. Accordingly, it is also becoming common to use such a mobile terminal for the purpose of data management.

Since management of paper documents is troublesome and transporting a large volume of documents is not easy, there is an increasing demand to handle various kinds of document data by using a mobile terminal. To create electronic data with a conventional fax system, it is necessary to first print a document and then scan the document, which is troublesome work. Also, it is wasteful to first print a document from electronic data and then create electronic data again from the document.

Another way to obtain electronic data is to transfer fax data, stored in the confidential box, to a given mail address. However, it is troublesome to manually input a mail address or to select an address from an address book, and such operation is a burden for the user. Although technology has been developed for automatically transferring received data to a transfer destination mail address that has been determined in advance, it is common that the confidential box is set for a predetermined organizational unit, as described above. Therefore, it is necessary to transfer the data by e-mail to all the users using the confidential box, or, when transferring the data to a particular user, to conduct additional work for specifying the user. As a result, the amount of unnecessary mail processing is increased, and such processing increases the burden on each user.

### SUMMARY OF THE INVENTION

According to one aspect of the present invention, there is provided a mobile terminal comprising: a communication unit configured to perform near field communication with a peripheral apparatus; a unit configured to switch from near field communication performed by the communication unit to communication via another communication path; and an obtaining unit configured to transmit authentication information of a fax to the peripheral apparatus, and to obtain a fax data set corresponding to the authentication information from the peripheral apparatus via the another communication path.

According to another aspect of the present invention, there is provided a method of controlling a mobile terminal, comprising: performing near field communication with a peripheral apparatus; switching from near field communication to communication via another communication path; and transmitting authentication information of a fax to the peripheral apparatus, and obtaining a fax data set corresponding to the authentication information from the peripheral apparatus via the another communication path.

According to another aspect of the present invention, there is provided a non-transitory computer-readable medium storing a computer program for enabling a computer to serve as: a communication unit configured to perform near field communication with a peripheral apparatus; a unit configured to switch from near field communication performed by the communication unit to communication via another communication path; and an obtaining unit configured to transmit authentication information of a fax to the peripheral apparatus, and to obtain a fax data set corresponding to the authentication information from the peripheral apparatus via the another communication path.

The present invention provides improved usability when transmitting data stored in a fax machine to a mobile terminal.

Further features of the present invention will become apparent from the following description of exemplary embodiments (with reference to the attached drawings).

### BRIEF DESCRIPTION OF THE DRAWINGS

FIG. 1 is a diagram illustrating an example of the configuration of a fax system.

FIG. 2 is a diagram illustrating an example of the hardware configuration of each apparatus included in the fax system.

FIG. 3 is a diagram illustrating an example of the software configuration of each apparatus included in the fax system.

FIG. 4 is a flowchart for a mobile terminal according to a first embodiment.

FIG. 5 is a flowchart for a fax machine according to the first embodiment.

FIG. 6 is a flowchart for a mobile terminal according to a second embodiment.

FIG. 7 is a flowchart for a fax machine according to the second embodiment.

FIG. 8 is a flowchart for a mobile terminal according to a third embodiment.

FIG. 9 is a flowchart for a fax machine according to the third embodiment.

FIG. 10 is a flowchart for a mobile terminal according to a fourth embodiment.

FIG. 11 is a flowchart for a fax machine according to the fourth embodiment.

FIG. 12 is a flowchart for a mobile terminal according to a fifth embodiment.

FIG. 13 is a diagram illustrating an example of the configuration of an UI according to the fifth embodiment.

### DESCRIPTION OF THE EMBODIMENTS

The following describes embodiments of the present invention with reference to the drawings.

### First Embodiment

### [System Configuration]

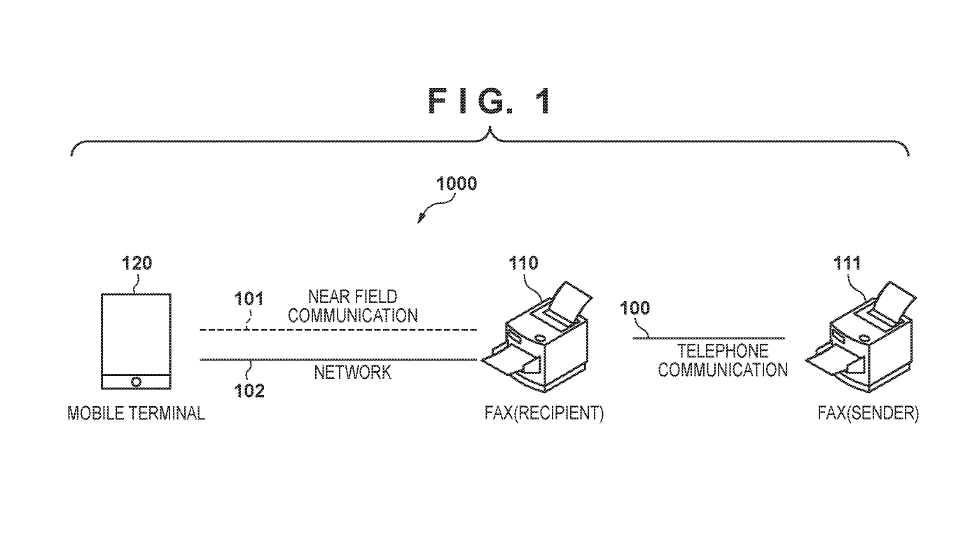

With reference to FIG. 1, a description is given to an example of the configuration of a fax system 1000, which is an image communication system according to the present embodiment. The fax system 1000 includes a fax (recipient) 110 that serves as a recipient of fax data, a fax (sender) 111 that serves as a sender of fax data, and a mobile terminal 120 that serves as a terminal apparatus. The fax (recipient) 110 and the fax (sender) 111, which are fax machines, are capable of connecting to each other via telephone communication 100, and of exchanging fax data with each other. The fax (recipient) 110 and the mobile terminal 120 are capable of connecting to and communicating with each other via a network 102. Furthermore, the fax (recipient) 110 and the mobile terminal 120 are capable of connecting to and communicating with each other via near field communication 101 in a similar manner. The network 102 is a communication network such as a local area network (LAN), Bluetooth (registered trademark), or the Internet. Thus, the fax machines and the mobile terminal can switch among data communication paths according to the need. Note that the two communication paths may be configured to allow for simultaneous transmission/reception of different data sets.

Communication schemes for the near field communication 101 and the network 102 are not particularly limited, and any well-known technology may be adopted. In the present Specification, for the sake of convenience, the communication scheme using the near field communication 101 may be referred to as the first communication scheme and the communication scheme using the network 102 may be referred to as the second communication scheme. Although two fax machines are illustrated in FIG. 1, the number of fax machines is not limited to two and may be greater. In addition, whether each fax machine serves as a recipient or a sender is not necessarily determined in a fixed manner, and each fax machine may serve as either a recipient or a sender according to, for example, the relationship with another fax machine.

[Hardware Configuration]

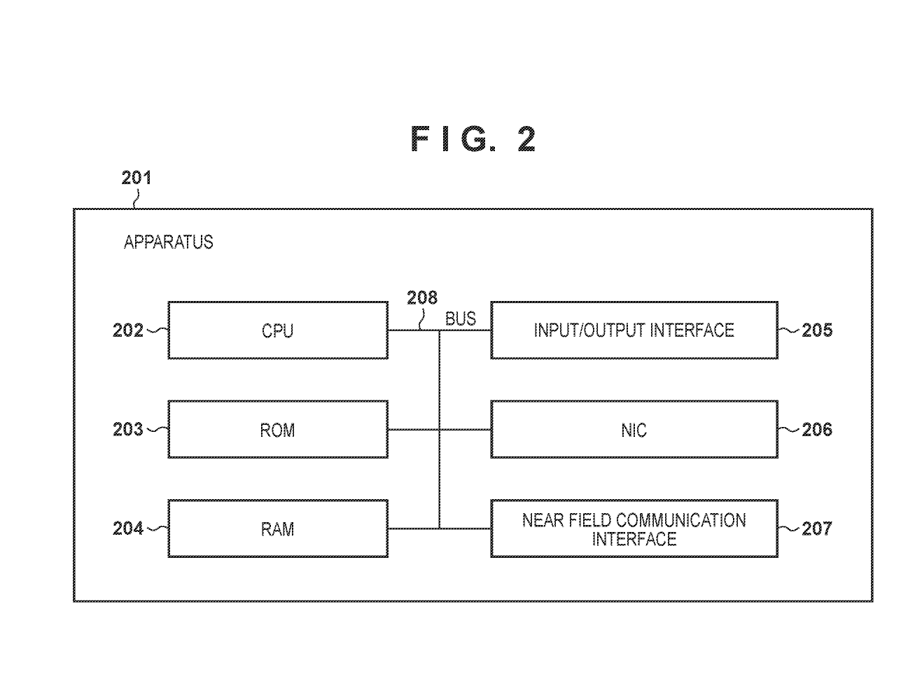

The following describes an example of the hardware configuration of each apparatus included in the fax system 1000, with reference to FIG. 2. An apparatus 201 is an example structure representing a fax or a mobile terminal included in the fax system 1000. Note that the figure only shows primary units for performing processing according to the present embodiment, and the apparatus 201 may include other units.

A central processing unit (CPU) 202 executes various programs stored in a ROM 203 for example, thereby achieving various functions. The CPU 202 also controls the apparatus 201 in a centralized manner. A read only memory (ROM) 203 is a storage unit, and stores various programs according to the present embodiment. A random access memory (RAM) 204 is a volatile storage unit. The processing according to the present embodiment is achieved by the CPU 202 loading a program stored in the ROM 203 onto the RAM 204 and executing the program. The RAM 204 is also used as a temporary work area for the CPU 202.

An input/output interface 205 is an interface for, for example, transmitting data to a display apparatus (not illustrated in the drawing) which serves as a display unit and is connected to the apparatus 201, and receiving data and instructions from a pointing device, etc. (not illustrated in the drawing) which serves as an input unit. Note that in the case of the mobile terminal 120, the input/output interface 205 may be a touch panel display apparatus. A network interface card (NIC) 206 is a unit for connecting the apparatus 201 included in the fax system 1000 to the network 102. A near field communication interface 207 is a unit for connecting each apparatus included in the fax system 1000 to one another via the near field communication 101. The units described above are connected to each other via a bus 208, and are thereby capable of exchanging data with each other.

[Software Configuration]

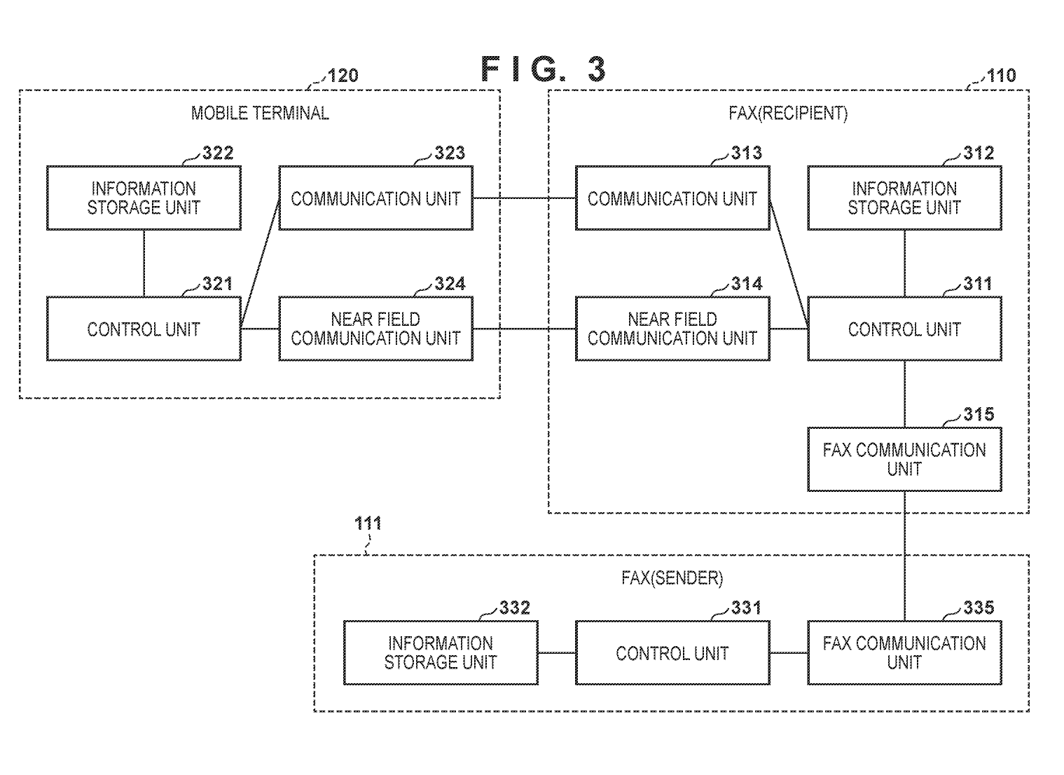

The following describes an example of the software configuration of each apparatus included in the fax system 1000, with reference to FIG. 3. In the present embodiment, the programs for achieving software functions illustrated in FIG. 3 are stored in the ROM 203 of each apparatus, and the CPU 202 achieves the functions by loading a program onto the RAM 204 and executing the program.

The mobile terminal 120 includes a control unit 321, an information storage unit 322, a communication unit 323, and a near field communication unit 324. The control unit 321 controls cooperation among the units included in the mobile terminal 120 and communication with an external apparatus. The information storage unit 322 is a database for storing data according to the present embodiment. The communication unit 323 performs network communication with a communication unit 313 of the fax (recipient) 110 via the network 102. The near field communication unit 324 performs near field communication with a near field communication unit 314 of the fax (recipient) 110 via the near field communication 101.

The fax (recipient) 110 includes a control unit 311, an information storage unit 312, a communication unit 313, a near field communication unit 314, and a fax communication unit 315. The control unit 311 controls cooperation among the units included in the fax (recipient) 110 and communication with an external apparatus. The information storage unit 312 is a database for storing, for example, fax data and authentication information for the F code confidential box, received from the fax (sender) 111. The details of the authentication information are described below. The communication unit 313 performs communication with the communication unit 323 of the mobile terminal 120 via the network 102. The near field communication unit 314 performs near field communication with the near field communication unit 324 of the mobile terminal 120 via the near field communication 101. The fax communication unit 315 connects to a fax communication unit 335 of the fax (sender) 111 via the telephone communication 100, and performs communication relating to transmission and reception of fax data.

The fax (sender) 111 includes a control unit 331, an information storage unit 332, and a fax communication unit 335. The control unit 331 controls cooperation among the units included in the fax (sender) 111 and communication with an external apparatus. The information storage unit 332 is a database for storing, for example, fax data and authentication information for the F code bulletin board, which are to be transmitted to the fax (recipient) 110. The fax communication unit 335 connects to the fax communication unit 315 of the fax (recipient) 110 via the telephone communication 100, and performs communication relating to transmission and reception of fax data.

[Processing Flow]

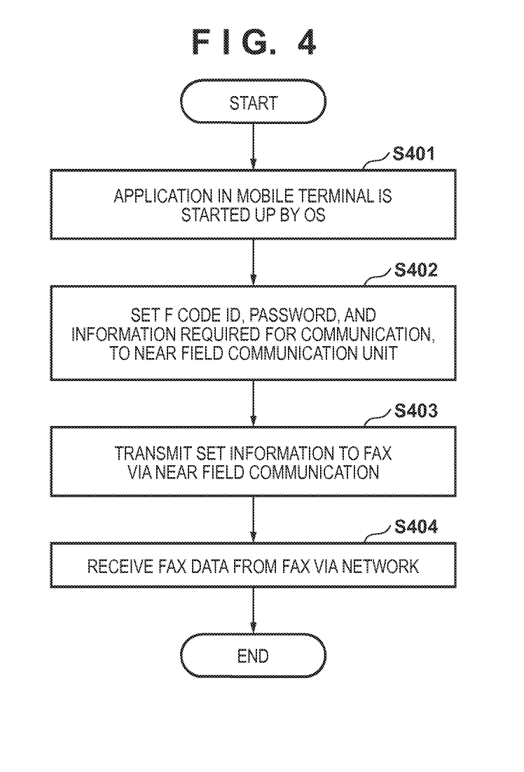

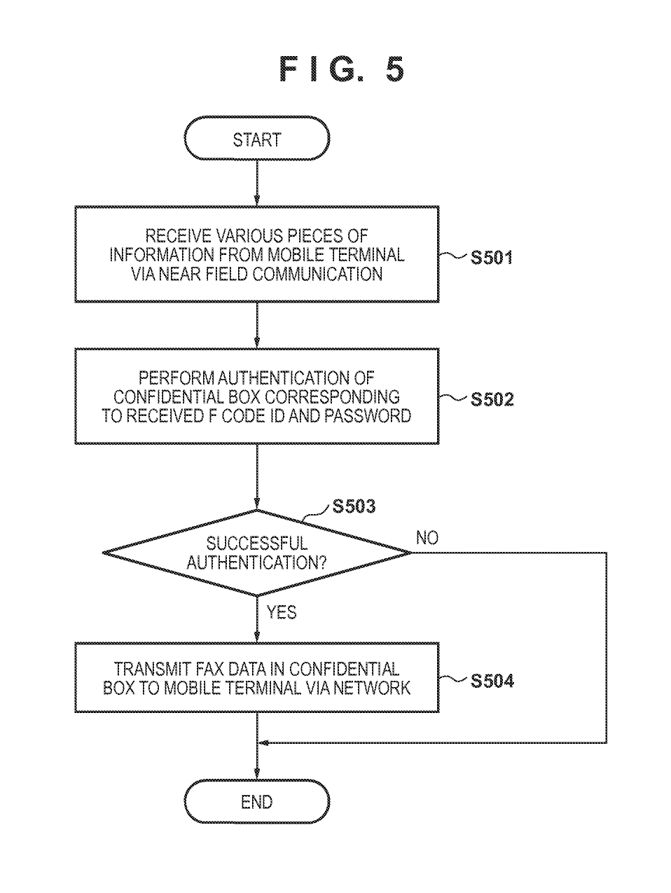

The following describes a processing flow for applications used in the fax system 1000, with reference to FIG. 4 and FIG. 5. FIG. 4 illustrates a processing flow for an application in the mobile terminal 120, and FIG. 5 illustrates a processing flow for an application in the fax (recipient) 110. In the present embodiment, a description is given to an example case where the processing performed on the mobile terminal 120 is achieved by an application that can be additionally installed into or uninstalled from the mobile terminal 120. This application operates and functions under the control of an OS (not illustrated in the drawing) provided within the mobile terminal 120.

Suppose that the authentication information for using the confidential function among the F code functions is a pair of an F code ID and a password. The F code ID is uniquely-defined identification information associated with the confidential box. More specifically, due to the confidential function, the storage unit (e.g. the RAM 204) inside the fax machine has a plurality of confidential boxes serving as a plurality of storage areas, and each confidential box is associated with an F code ID and a password. Suppose that the F code IDs and the passwords have been issued before execution of each processing flow, and they are used in all the apparatuses in the fax system 1000.

(Mobile Terminal)

First, a description is given with reference to FIG. 4. At S401, the application is started up by the OS in the mobile terminal 120 according to a user instruction. At S402, the application sets, to the near field communication unit 324, the F code ID and the password input by the user and information required for communication with the communication unit 323 of the mobile terminal 120. Suppose that the F code ID and the password used here are taken over from the previous input or have been set in advance, and now they are under the management of the mobile terminal 120. The user does not need to manually input the F code ID and the password every time. In addition, when the fax (recipient) 110 has an in-box that does not need an F code ID or a password, the F code ID and the password may be omitted.

The application may always remain in the started-up state so that the user can use the application anytime. Alternatively, the application may be started up every time the user wishes to use the application. Furthermore, the application may have both of these features. Usually, the timing with which various pieces of information are set to the near field communication unit 324 is, for example, when the application is started up, or the application is switched to the “receiving mode”, which is a mode of preparing for receiving data from the outside. However, the timing is not limited to the above. For example, overwriting may be permitted when another application uses the near field communication 101, and the information in the near field communication unit 324 may be overwritten again when the other application stops running or when the other application finishes using the near field communication 101. The information used for communication with the communication unit 323 of the mobile terminal 120 is, for example, an e-mail address and information required for establishing Bluetooth (registered trademark) communication. The required information varies depending on the protocol of communication via the network 102, for example.

At S403, after the pieces of information are set at S402, the application in the mobile terminal 120 performs near field communication with the fax (recipient) 110 via the near field communication 101. This communication is achieved by the user moving the mobile terminal 120 or the near field communication unit 324 of the mobile terminal 120 to be in the range of the near field communication 101 in which communication with the fax (recipient) 110 as a peripheral apparatus or with the near field communication unit 314 of the fax (recipient) 110 can be performed. The range of the near field communication 101 varies depending on the communication scheme, for example. When the near field communication units 314 and 324 are moved closer to be in the range of the near field communication 101, an attempt is automatically made to establish a connection via the near field communication 101, and communication starts when the connection is successfully established. Upon the starting of the communication, the application transmits, to the fax (recipient) 110, the pair of the F code ID and the password, and the communication information, which are the pieces of information set at S402. These pieces of information may be transmitted upon a request for receiving issued by the fax (recipient) 110 to the mobile terminal 120, or upon a request for transmitting issued by the mobile terminal 120 to the fax (recipient) 110.

After that, the application makes preparations for reception (e.g. preparations for receiving a mail) according to the communication information which has been set at S402, and waits until the fax (recipient) 110 transmits data. Upon the starting of the communication between the mobile terminal 120 and the fax (recipient) 110, the mobile terminal 120, at S404, receives the fax data from the fax (recipient) 110 via the network 102 through the communication. When, for example, the communication information, which has been set at S402, is incorrect or the data does not exist in the fax (recipient) 110, the application suspends the communication with the fax (recipient) 110, or does not start the communication in the first place. Upon the completion of receiving the fax data, or when the communication is suspended or has not been started, the processing flow for the application ends. Regarding the suspension of the communication, etc., the application in the mobile terminal 120 may make a determination according to a time out with respect to the period for which no communication is performed, for example.

(Fax)

Next, a description is given to the processing flow for the fax (recipient) 110, with reference to FIG. 5. At S501, the fax (recipient) 110 performs near field communication with the mobile terminal 120 via the near field communication 101, thereby receiving various information. The information received at this stage includes the authentication information for the fax, such as the F code ID and the password described as to S402 in FIG. 4, and information required for communication with the mobile terminal 120 (the communication unit 323) via the network 102.

At S502, the fax (recipient) 110 searches the information storage unit 312 for the confidential box corresponding to the F code ID received from the mobile terminal 120. When the corresponding confidential box exists, the fax (recipient) 110 makes an attempt to authenticate the confidential box by using the received password. When the authentication is successful (YES at S503), the fax (recipient) 110, at S504, operates the communication unit 313 and connects to the communication unit 323 of the mobile terminal 120 via the network 102 by using the information obtained at S501. Thus, the communication path is switched from the near field communication 101 to the network 102. Then, the fax (recipient) 110 transmits the fax data stored in the corresponding confidential box to the mobile terminal 120 via the network 102. The fax data may be transmitted as it is to the mobile terminal 120, or be converted before the transmission to data in a common image format such as JPEG. When the authentication fails, when the corresponding confidential box does not exist, or when no data exists in the corresponding confidential box (NO at S503), the fax (recipient) 110 ends the processing flow. At this stage, the fax (recipient) 110 may notify the mobile terminal 120 that the F code ID or the password is incorrect, by using an application.

Through the operation described above, fax data received by and stored in a fax machine can be transferred to a mobile terminal in a simple manner. As a result, the present embodiment provides improved usability in obtaining data stored in a fax machine from a mobile terminal.

### Second Embodiment

The first embodiment describes a method of transferring fax data from a fax to a mobile terminal. However, some users might wish to perform printing instead of obtaining the data. Considering this, the present embodiment describes a configuration for supporting the both cases, by determining whether the user wishes to obtain data or print the data, according to whether or not the information obtained from the mobile terminal via the near field communication includes communication information. Note that the system configuration, the hardware configuration, and the software configuration are the same as the first embodiment, and detailed explanation thereof is omitted here.

[Processing Flow]

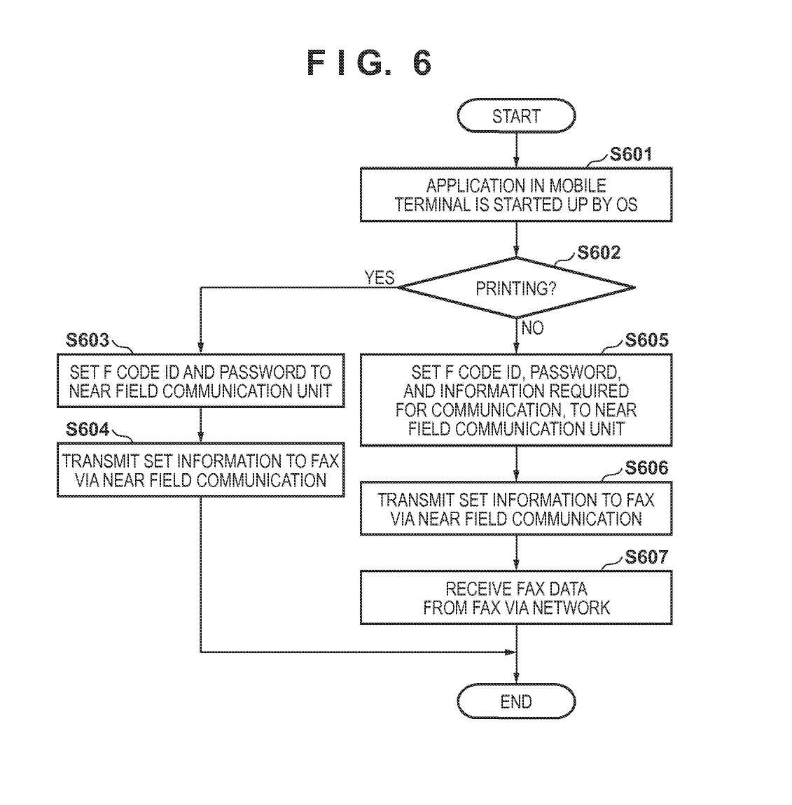

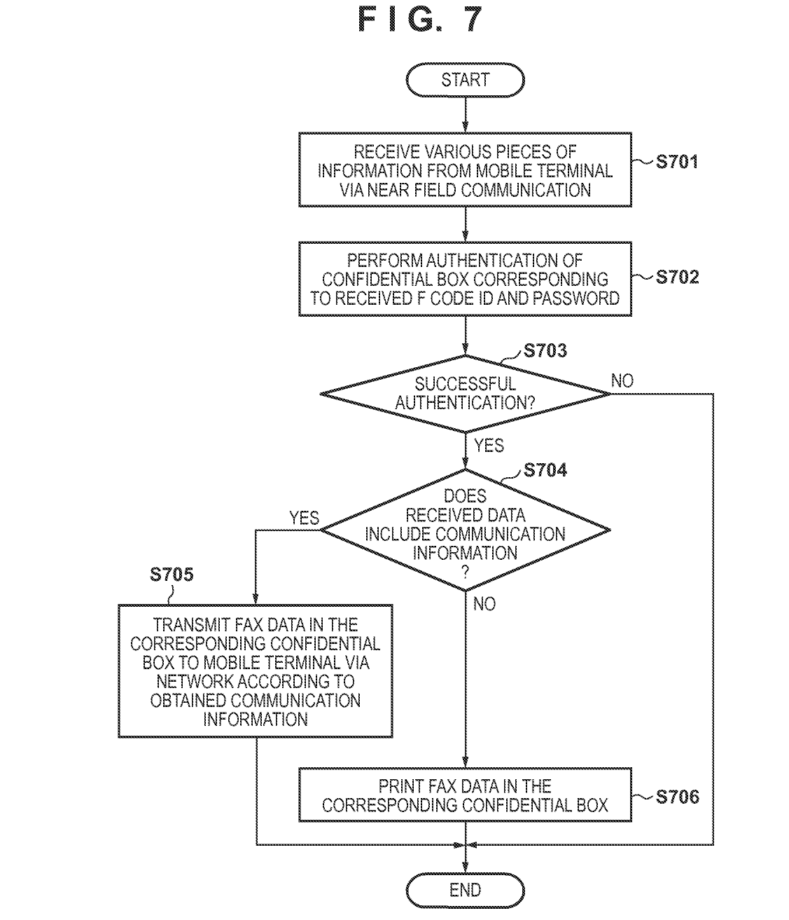

The following describes the processing flow for a fax system according to the present embodiment, with reference to FIG. 6 and FIG. 7. FIG. 6 illustrates a processing flow for the mobile terminal 120, and FIG. 7 illustrates a processing flow for the fax (recipient) 110.

(Mobile Terminal)

First, a description is given with reference to FIG. 6. At S601, the application is started up by the OS in the mobile terminal 120 according to a user instruction. At S602, the application determines whether or not the user is requesting for printing. When determining that the user is requesting for printing (YES at S602), the application moves to S603. When determining that printing is not to be performed, i.e., when determining to receive fax data (NO at S602), the application moves to S605. The determination at this stage may be performed based on a set value previously selected by the user and stored, or based on a mode of the application such as “printing mode” for printing or “receiving mode” for receiving.

In the case of performing printing (YES at S602), the application, at S603, sets to the near field communication unit 324 the F code ID and the password input by the user. At S604, the application transmits the various pieces of information, which have been set at S603, to the fax (recipient) 110 via the near field communication 101. Then, the application ends the flow. The near field communication, etc. is the same as the first embodiment, and therefore detailed explanation thereof is omitted here.

In the case of receiving fax data (NO at S602), S605 through S607 are the same as S402 through S404 in FIG. 4 described in the first embodiment, and therefore detailed explanation thereof is omitted here.

(Fax)

Next, a description is given to a processing flow for the fax (recipient) 110, with reference to FIGS. 7. S701 and S702 in FIG. 7 are the same as S501 and S502 in FIG. 5 described in the first embodiment, and therefore detailed explanation thereof is omitted here.

At S703, the fax (recipient) 110 searches the inside of the fax (recipient) 110 for the confidential box corresponding to the F code ID included in the information received from the mobile terminal 120, and when the corresponding confidential box exists, the fax (recipient) 110 makes an attempt to authenticate the confidential box by using the password received at S701. When the authentication fails (NO at S703), the fax (recipient) 110 ends the processing flow.

When the authentication is successful (YES at S703), the fax (recipient) 110, at S704, determines whether the communication information required for communication with the mobile terminal 120 via the network 102 is included in the information received at S701. When the communication information is included in the received information (YES at S704), the fax (recipient) 110 determines the received information to be a request for obtaining data, and moves to S705. At S705, the fax (recipient) 110 communicates with the mobile terminal 120 via the network 102 by using the received communication information, and transmits the fax data. This processing is the same as S504 in FIG. 5 described in the first embodiment.

When the communication information is not included in the received information (NO at S704), the fax (recipient) 110 determines the received information to be a request for printing, and moves to S706. At S706, the fax (recipient) 110 prints the fax data stored in the confidential box corresponding to the F code ID received at S701.

As described above, in addition to achieving the effects of the first embodiment, the second embodiment implements an easy-to-use fax system that allows the user to select whether to transmit the fax data to the mobile terminal or to print the fax data.

### Third Embodiment

The first and the second embodiment describe receiving and printing of fax data stored in the confidential box. In addition to the confidential function, however, the F code functions include the bulletin board function as well. The present embodiment describes a fax system that determines whether a request is related to the F code bulletin board function or to the F code confidential function according to whether the source number, which indicates the source of the F code bulletin board, exists or not. Note that the system configuration, the hardware configuration, and the software configuration are the same as the first embodiment, and detailed explanation thereof is omitted here.

[Processing Flow]

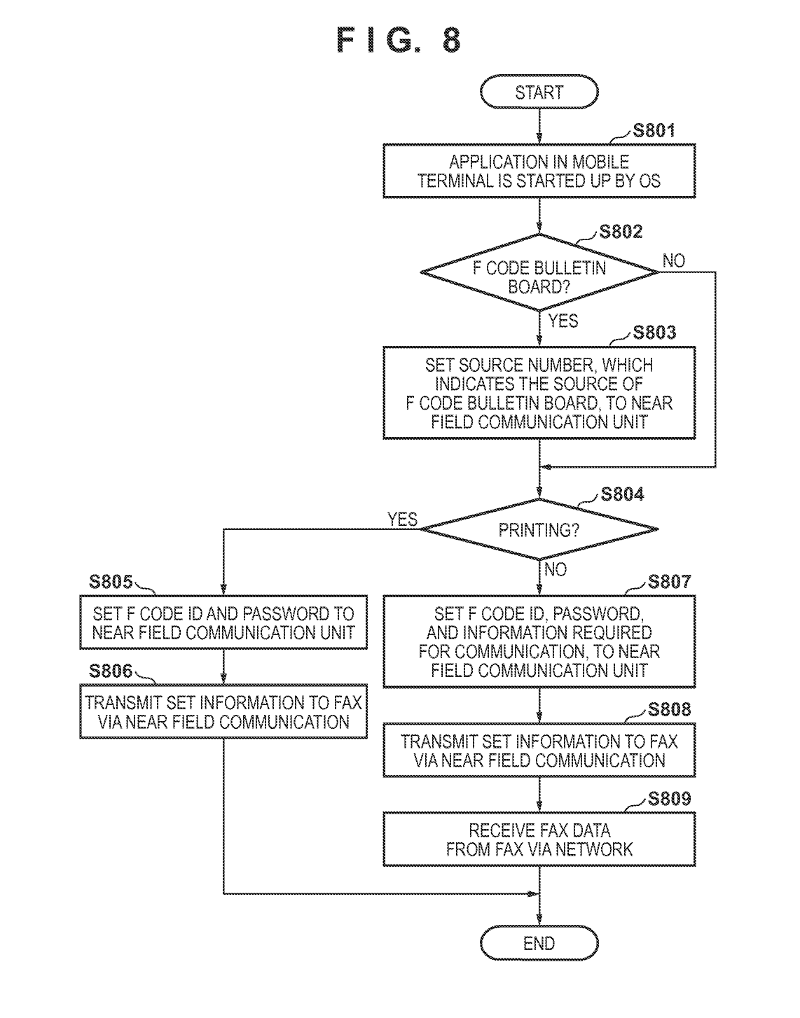

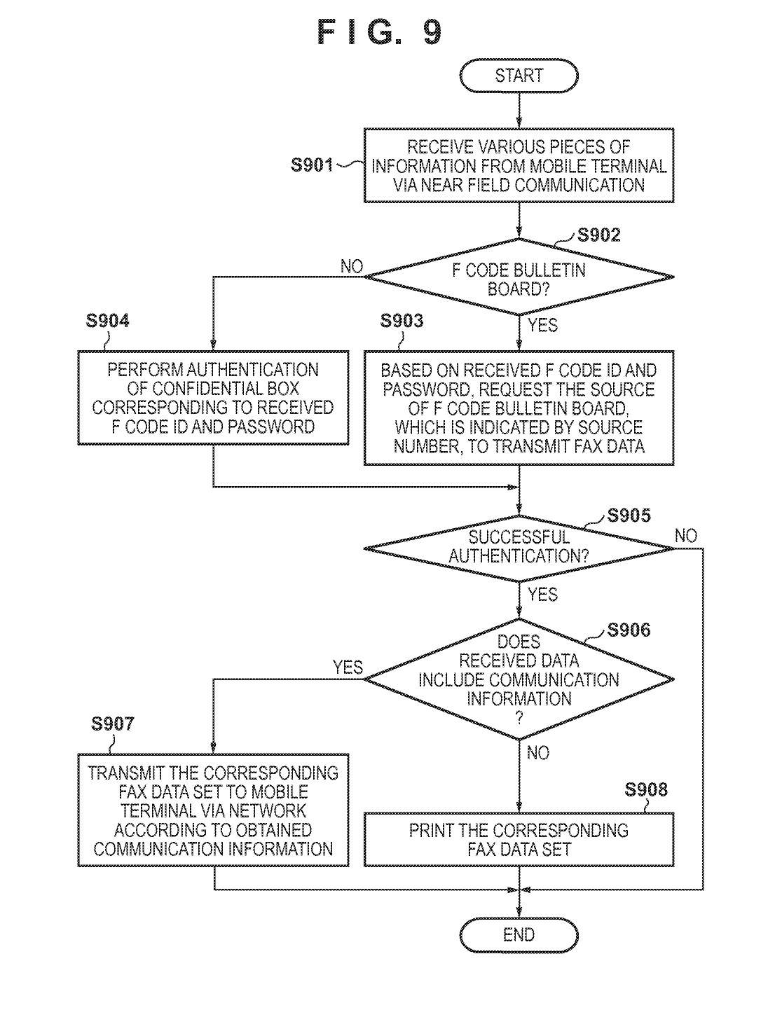

The following describes a processing flow for a fax system according to the present embodiment, with reference to FIG. 8 and FIG. 9. FIG. 8 illustrates a processing flow for the mobile terminal 120, and FIG. 9 illustrates a processing flow for the fax (recipient) 110.

(Mobile Terminal)

At S801, the application is started up by the OS in the mobile terminal 120 according to a user instruction. At S802, the application determines whether or not to use the F code bulletin board function. In the case of using the F code bulletin board function (YES at S802), the application moves to S803. In the case of not using it (NO at S802), the application moves to S804. The determination at this stage may be performed based on whether the fax number of the fax (sender) 111, which serves as the source of the F code bulletin board, has been input by the user. The actual fax number may be associated with another application such as an address book in the mobile terminal 120 so that the user can select the number. Alternatively, the fax number may be determined by using a setting value stored in advance by the user.

At S803, the application sets the source number to the near field communication unit 324. This number may also be stored in the application in advance, or input by the user, or set with reference to information for another application. Then, the application moves to S804. S804 through S809 in FIG. 8 are the same as S602 through S607 in FIG. 6 described in the second embodiment, and therefore detailed explanation thereof is omitted here.

(Fax)

Next, a description is given to a processing flow for the fax (recipient) 110, with reference to FIG. 9. S901 is the same as S701 in FIG. 7 described in the second embodiment.

At S902, the fax (recipient) 110 determines whether the fax number of the fax (sender) 111 is included in the information received at S901. When the fax number is included in the received information (YES at S902), the fax (recipient) 110 determines the received information to be a request for the F code bulletin board function, and moves to S903. At S903, the fax (recipient) 110 requests the fax (sender) 111 to transmit the F code bulletin board fax data, by using the fax number of the fax (sender) 111 and the pair of the F code ID and the password. When the fax number is not included in the received information (NO at S902), the fax (recipient) 110 determines the received information to be a request for the F code confidential function, and moves to S904. At S904, the fax (recipient) 110 performs the authentication of the corresponding confidential box. This processing is the same as S502 in FIG. 5 described in the first embodiment.

At S905, after S903 or S904, the fax (recipient) 110 checks the result of the authentication. When the authentication is successful (YES at S905), the fax (recipient) 110 moves to S906. When the authentication fails (NO at S905), the fax (recipient) 110 ends the processing flow. Regarding the determination at this stage, in the case of the F code bulletin board function, the fax (recipient) 110 makes the determination according to the result of the authentication performed by the fax (sender) 111, and in the case of the F code confidential function, the fax (recipient) 110 makes the determination by performing authentication on its own. In the case of the F code bulletin board function, the fax (recipient) 110 receives the fax data from the fax (sender) 111 at this point of time, or at any point of time before subsequent printing or data transmission is performed. Then, the fax (recipient) 110 prints the received fax data, or transmits the fax data to the mobile terminal 120. S906 through S908 in FIG. 9, which relate to printing and transmission of fax data, are the same as S704 through S706 in FIG. 7 described in the second embodiment, and therefore detailed explanation thereof is omitted here.

As described above, in addition to achieving the effects of the first embodiment and the second embodiment, the third embodiment makes the F code bulletin board function available in a fax system that allows the user to select whether to transmit the fax data to the mobile terminal or to print the fax data.

### Fourth Embodiment

Regarding the F code confidential function, the methods according to the first embodiment through the third embodiment are of printing or transmitting all the fax data sets in the corresponding confidential box. However, as described above, it is common that a single box is shared among multiple people, for example among people belonging to a predetermined organizational unit. Therefore, there is a demand to handle only a specified data set from among the fax data sets. Here, the confidential function requires that the F code ID and the password be provided to the sender of a fax data set in advance. Therefore, the user can specify the sender of the fax data set that the user wishes to obtain. Taking the advantage of attribute information (e.g. the fax number of the sender) being added to the fax data set, the present embodiment provides a method of selecting/extracting a data set that the user wishes to receive or print, by transmitting the information of the sender to the recipient fax machine. Note that the system configuration, the hardware configuration, and the software configuration are the same as the first embodiment, and detailed explanation thereof is omitted here.

[Processing Flow]

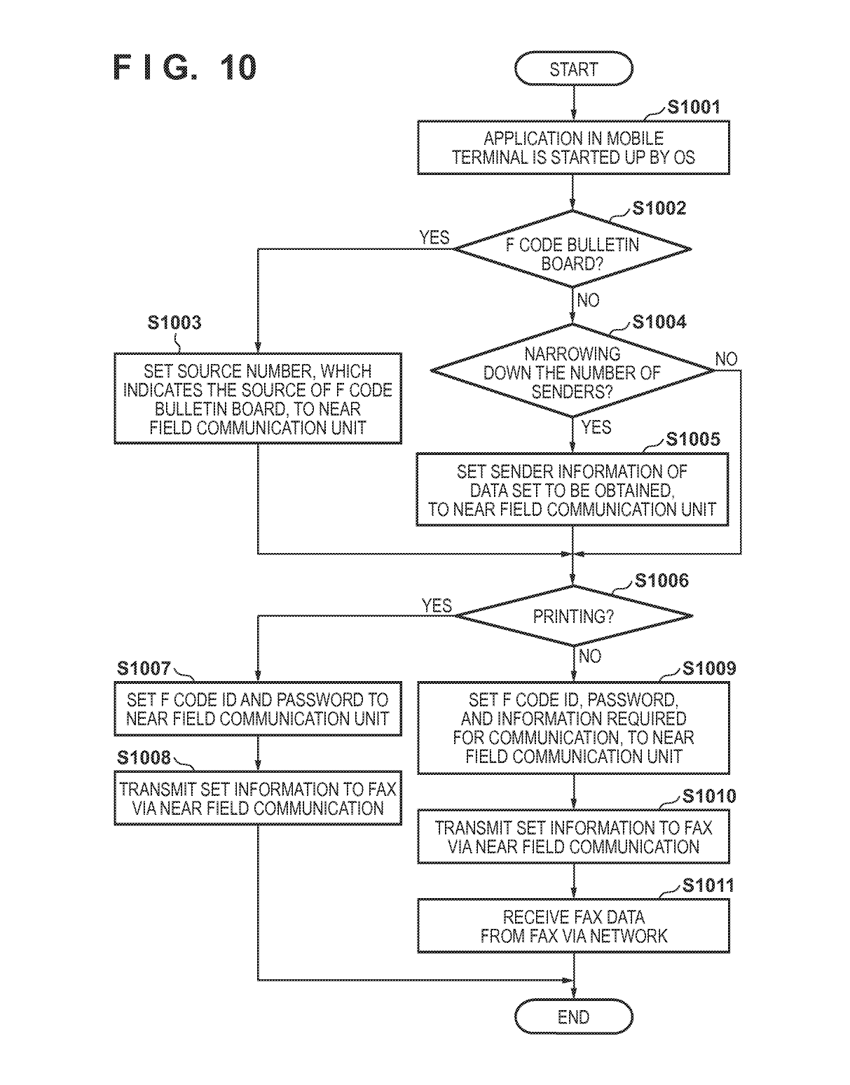

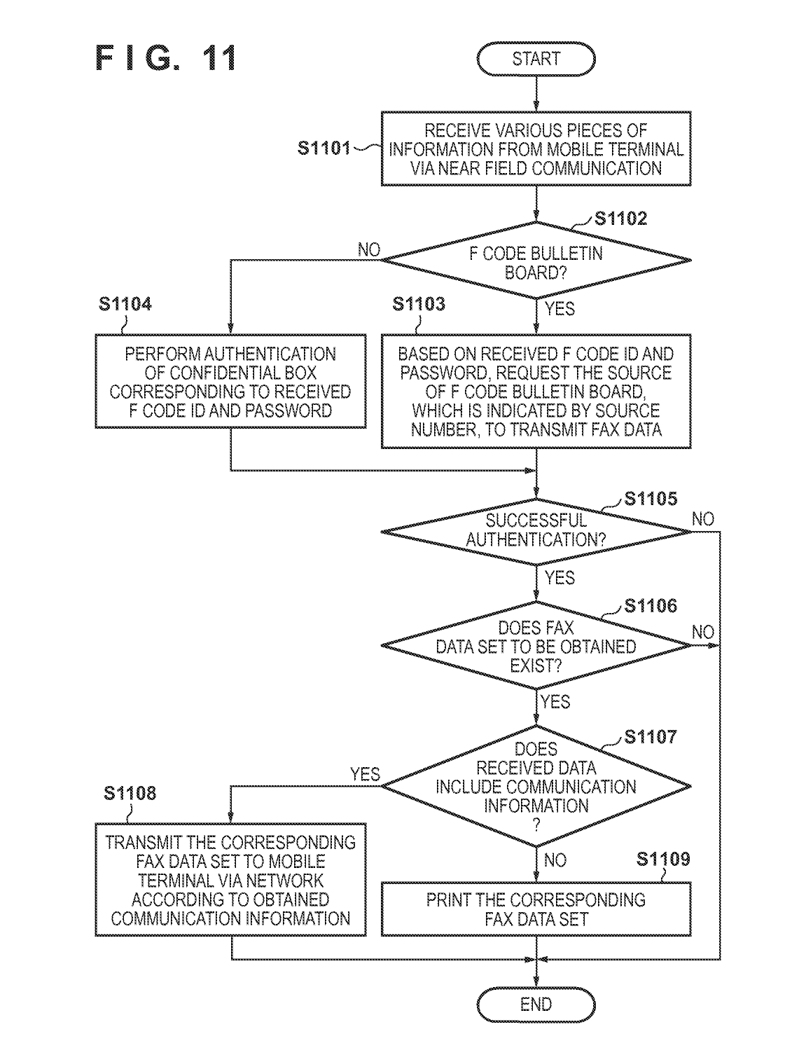

The following describes a processing flow for a fax system 1000 according to the present embodiment, with reference to FIG. 10 and FIG. 11. FIG. 10 illustrates a processing flow for the mobile terminal 120, and FIG. 11 illustrates a processing flow for the fax (recipient) 110.

(Mobile Terminal)

At S1001, the application is started up by the OS in the mobile terminal 120 according to a user instruction. At S1002, the application determines whether or not to use the F code bulletin board function. The following describes only the F code confidential function according to the present embodiment, and explanation of the F code bulletin board function already described in the third embodiment is omitted. S1003 in FIG. 10 is the same as S803 in FIG. 8 described in the second embodiment.

When the application determines not to use the F code bulletin board function, in other words, when the application determines to use the F code confidential function (NO at S1002), the application, at S1004, determines whether to narrow down the number of senders. In the case of narrowing down the number of senders (YES at S1004), the application moves to S1005. In the case of not narrowing down the number of senders (NO at S1004), the application moves to S1006. This determination can be made based on whether or not sender information used for narrowing down the number of senders has been input by the user. In the present embodiment, the sender information is the telephone number or the user name of the sender, for example. Note that the information may be associated with another application such as an address book in the mobile terminal 120 so that the user can select the information from another application. Alternatively, the information may be determined by using a setting value stored in advance by the user. At S1005, the application sets the sender information to the near field communication unit 324. S1006 through S1011 in FIG. 10 are the same as S602 through S607 in FIG. 6 described in the second embodiment, and therefore detailed explanation thereof is omitted here.

(Fax)

Next, a description is given to a processing flow for the fax (recipient) 110, with reference to FIG. 11. S1101 through S1105 are the same as S901 through S905 in FIG. 9 described in the third embodiment, and therefore detailed explanation thereof is omitted here.

When the authentication is successful (YES at S1105), the fax (recipient) 110 moves to S1106. At S1106, the fax (recipient) 110 determines whether or not the fax data set of the corresponding sender exists in the confidential box, by using the sender information for narrowing down, which is included in the information received at S1101. When the corresponding fax data set exists (YES at S1106), the fax (recipient) 110 moves to S1107. The fax (recipient) 110 moves to S1107 even when not having received the sender information. When the corresponding fax data set does not exist (NO at S1106), the fax (recipient) 110 ends the processing flow.

S1107 through S1109 in FIG. 11 are the same as S906 through S908 in FIG. 9 described in the third embodiment, and therefore detailed explanation thereof is omitted here. Through these steps according to the present embodiment, only the fax data set found in S1106 is to be printed or transmitted.

As described above, in addition to achieving the effects of the first embodiment through the third embodiment, the present embodiment allows the user to select the fax data set that the user wishes to receive from among the data sets in the confidential box by checking the senders, and allows for printing of the fax data set, or transmission of the fax data set to the mobile terminal.

### Fifth Embodiment

In recent years, technology of providing a notification to a mobile terminal via a notification server has become common. By using this technology, the present embodiment provides a method of more easily selecting the data set to be received or printed, which is based on the method according to the fourth embodiment. Note that the system configuration, the hardware configuration, and the software configuration are the same as the first embodiment, and explanation thereof is omitted here.

[Processing Flow]

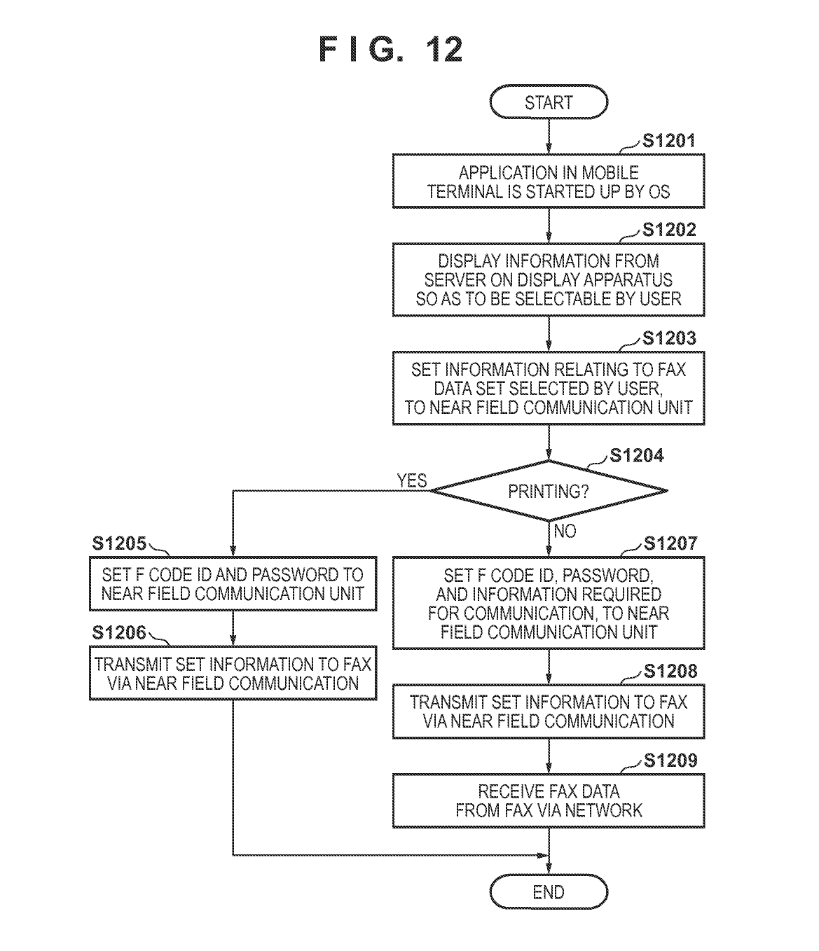

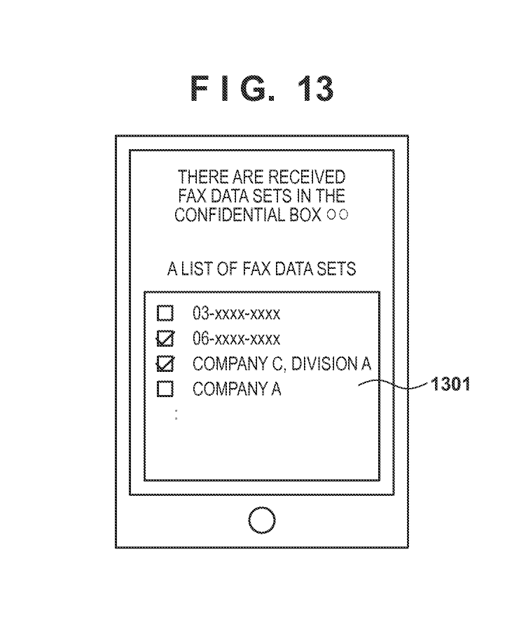

The following describes a processing flow for a fax system according to the present embodiment, with reference to FIG. 12. The UI for achieving this processing flow is described with reference to FIG. 13. FIG. 12 illustrates a processing flow for the mobile terminal 120. The following describes only the confidential function.

At S1201, the application is started up by the OS in the mobile terminal 120 according to a user instruction. At S1202, the application receives a notification from a notification server (not illustrated in the drawing) via, for example, the network 102, and displays the notification on a display apparatus (not illustrated in the drawing) that is provided in the mobile terminal 120. Here, the application may receive the notification only while the application is running. Alternatively, the notification may trigger S1201 by, for example, using the functions of the OS. In the present embodiment, suppose that the notification includes, for example, the F code ID that indicates the confidential box of the fax (recipient) 110, and pieces of sender information respectively corresponding to the fax data sets stored in the confidential box.

FIG. 13 illustrates an example of the UI displayed when the notification is received. In the present embodiment, as shown in the UI 1301, the pieces of sender information respectively corresponding to the fax data sets stored in the confidential box are displayed in the form of a list. Furthermore, the pieces of sender information are displayed such that the user can select the piece of sender information of the data set that the user wishes to obtain. Note that the user may be allowed to ignore the list and use the F code bulletin board function. If this is the case, the processing is performed according to the flows described in the third and fourth embodiment. At S1203, the application sets, to the near field communication unit 324, the information relating to the fax data set selected by the user viewing the UI 1301 shown in FIG. 13. S1204 through S1209 in FIG. 12 are the same as S1006 through S1011 in FIG. 10 described in the fourth embodiment, and therefore detailed explanation thereof is omitted here.

The flow for the fax (recipient) 110 is almost the same as in FIG. 11 described in the fourth embodiment, and is therefore not illustrated. Note that when the fax (recipient) 110 according to the present embodiment receives a fax data set addressed to the confidential box from the outside, the fax (recipient) 110 provides a reception notification to the notification server (not illustrated in the drawing) by, for example, performing communication via the network 102. The reception notification transmitted by the fax (recipient) 110 to the notification server (not illustrated in the drawing) includes, for example, the F code ID, the sender information of the sender of the fax data set, and information of mobile terminals that can be the destinations of a notification. Information of the mobile terminals that can be the destinations of a notification is registered in the fax (recipient) 110 or in the notification server in advance, and is related to the users of the corresponding confidential box.

The notification server transmits the reception notification received from the fax (recipient) 110 to the mobile terminal 120 by performing communication primarily via the network 102 according to the information of the mobile terminals which is contained in the reception notification or is registered in advance.

As described above, the present embodiment provides the user with pieces of information respectively corresponding to received fax data sets in the confidential box, allows the user to select a piece of information, and transmits the selected piece of information to the fax, thereby allowing the user to easily print or transmit, to the mobile terminal, the fax data set sent by the sender specified by the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory apparatus, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-083105, filed Apr. 14, 2014, which is hereby incorporated by reference herein in its entirety.

What is claimed is:

1. A mobile terminal comprising:
a communication unit configured to perform near field communication with a peripheral apparatus;
a unit configured to switch from near field communication performed by the communication unit to communication via another communication path; and
an obtaining unit configured to transmit authentication information of a fax to the peripheral apparatus, and to obtain a fax data set corresponding to the authentication information from the peripheral apparatus via said another communication path.

2. The mobile terminal according to claim 1,
wherein the obtaining unit transmits communication information to the peripheral apparatus, the communication information being for communication with the mobile terminal via said another communication path.

3. The mobile terminal according to claim 1,
wherein the obtaining unit transmits attribute information to the peripheral apparatus, and obtains a fax data set extracted according to the attribute information, the attribute information being used for extracting a fax data set from among fax data sets corresponding to the authentication information.

4. The mobile terminal according to claim 3,
wherein the peripheral apparatus is a fax machine, and
the attribute information is a fax number of a sender that has transmitted a fax data set to the fax machine.

5. The mobile terminal according to claim 1,
wherein the authentication information is set in association with each of a plurality of storage areas provided in a storage unit of the peripheral apparatus.

6. The mobile terminal according to claim 5,
wherein the authentication information is a pair of an F code ID and a password which are set for each confidential box for an F code confidential function.

7. A method of controlling a mobile terminal, comprising:
performing near field communication with a peripheral apparatus;
switching from near field communication to communication via another communication path; and
transmitting authentication information of a fax to the peripheral apparatus, and obtaining a fax data set corresponding to the authentication information from the peripheral apparatus via said another communication path.

8. The method according to claim 7,
wherein, in the obtaining, communication information is transmitted to the peripheral apparatus, the communication information being for communication with the mobile terminal via said another communication path.

9. The method according to claim 7,
wherein, in the obtaining, attribute information is transmitted to the peripheral apparatus, and a fax data set extracted according to the attribute information is obtained, the attribute information being used for extracting a fax data set from among fax data sets corresponding to the authentication information.

10. The method according to claim 9,
wherein the peripheral apparatus is a fax machine, and
the attribute information is a fax number of a sender that has transmitted a fax data set to the fax machine.

11. The method according to claim 7,
wherein the authentication information is set in association with each of a plurality of storage areas provided in a storage unit of the peripheral apparatus.

12. The method according to claim 11,
wherein the authentication information is a pair of an F code ID and a password which are set for each confidential box for an F code confidential function.

13. A non-transitory computer-readable medium storing a computer program for enabling a computer to serve as:
a communication unit configured to perform near field communication with a peripheral apparatus;
a unit configured to switch from near field communication performed by the communication unit to communication via another communication path; and
an obtaining unit configured to transmit authentication information of a fax to the peripheral apparatus, and to obtain a fax data set corresponding to the authentication information from the peripheral apparatus via said another communication path.
